(19) United States
(12) Patent Application Publication
(10) Pub. No.: US 2016/0163089 A1
(43) Pub. Date: Jun. 9, 2016

(54) GRAPHICAL DATA REPRESENTATION

(71) Applicant: Bifold Fluidpower Limited, Manchester (GB)

(72) Inventors: Michael James Dowman, Leeds (GB); Nicholas Paul Whitehead, Manchester (GB)

(73) Assignee: Bifold Fluidpower Limited, Manchester (GB)

(21) Appl. No.: 14/907,168

(22) PCT Filed: Jul. 18, 2014
(86) PCT No.: PCT/EP2014/065547

§ 371 Date: Jan. 22, 2016

(30) Foreign Application Priority Data
Jul. 25, 2013 (GB) 1313292.3

(51) Int. Cl. G06T 15/04

(52) U.S. Cl. CPC G06T 15/04

(57) ABSTRACT

A method of generating a representation of graphical data based upon a plurality of stored floating point data values and a plurality of stored integer values. The method comprises reading a plurality of the integer values, reading a plurality of the floating point data values, each read floating point data value being based upon a respective read integer value, and generating a representation of the graphical data based upon the plurality of read floating point data values.

The present invention relates to methods for generating using and storing representations of graphical data.

Computers are ubiquitous in modern society, finding an ever increasing number of roles. Computers are now frequently used to display and manipulate graphical data in a variety of different applications. Such applications include, by way of example, computer aided design and computer gaming.

When graphical data is displayed on a display device such as a computer monitor, the graphical data is represented by an array of pixels, each pixel having a value which defines its colour within the graphical data. While the use of pixel based data is necessary to allow the display of graphical data it does not lend itself to ready manipulation of the graphical data by, for example, scaling. Another known way of representing graphical data is by way of various graphical primitives such as lines, polygons etc. Such a representation is sometimes referred to as a vector-based representation, given its reliance on vectors and vector based primitives. Vector-based representations are useful in that they typically more readily allow manipulation of the graphical data in a way which preserves the integrity and quality of the graphical data.

As graphical data becomes more widely used, there is a need to ensure that it is efficiently stored. This is particularly so when graphical data is used on devices which have limited physical storage such as mobile telephones, tablet computers and the like. As such, various data compression techniques have been developed. Some such data compression techniques work with pixel data and carry out various transforms to compress the data. A widely used compression technique of this type is JPEG compression.

There is also a need for techniques which allow vector-based graphics data to be efficiently and effectively stored. It is an object of some embodiments of the present invention to provide a method for generating and storing a representation of graphical data.

According to a first aspect of the invention, there is provided a method of generating a representation of graphical data based upon a plurality of stored floating point data values and a plurality of stored integer values. The method comprises reading a plurality of said integer values; reading a plurality of said floating point data values, each read floating point data value being based upon a respective read integer value; and generating a representation of said graphical data based upon said plurality of read floating point data values.

In this way, a plurality of stored indices can refer to a single stored floating point value. As such, where a floating point value occurs a plurality of times within data to be represented, storage requirements can be minimised by storing the floating point value only once, and storing plural references to the floating point value. Given that the references take the form of integer values, there is a considerable saving in storage space requirements given that integers can be stored in a smaller space than floating point values.

The floating point values may represent all or part of the graphical data. For example, the floating point values may represent points in vector space as discussed below.

The floating point values may be stored in a data structure providing an integer index for each stored floating point value. For example, the floating point values may be stored in a table. Each read integer value may be the index of a respective one of the floating point values so as to identify that floating point value.

Each of the integer values may have an associated sign, and each of said floating point values may be unsigned. Reading said plurality of floating point values may then comprise modifying a sign of at least some of the read floating point values based upon the sign of the respective read integer value. Such an arrangement may be advantageous in that only the magnitude of each required floating point value is stored and can be referred to by positively and negatively signed integers to generate positive and negative floating point numbers respectively. This further reduces storage requirements given that only a single floating point data item is required to potentially generate two different floating point values of equal magnitude but differing sign.

Said plurality of integer values may define a plurality of tuples and said generating may generate a plurality of tuples representing features of said graphical data.

At least some of said tuples may define respective points in a vector space. For example, each tuple may take the form of an n-dimensional vector in an n-dimensional vector space.

The generating may further comprise reading a plurality of vertex data items, each vertex data item identifying one of said tuples and each vertex data item representing a vertex in the graphical data. In this way a plurality of vertices of an object to be represented can be stored and can refer to the stored tuples. A plurality of coincident vertices can be separately represented (by respective vertex data items), but rely upon the same stored data (i.e. the same tuple) so as to reduce total required storage space.

The graphical data may be represented by a plurality of polygons and the generating may generate the polygons from the vertex data items. The polygons may be triangles. The polygons may define a connectivity for the vertices represented by the vertex data items so as to define part of the graphical data.

Some of said tuples may represent a point in a two-dimensional texture map, said point in said two dimensional texture map being associated with one of said vertices and said generating may comprise generating graphical data in which said point in said two dimensional texture map is applied to said one of said vertices.

The tuples may be pairs or triples, or tuples of other dimension.

At least some of the tuples may define a colour. The at least some of said tuples which define a colour may comprise a plurality of elements, each element providing a value for a respective colour channel. For example, the at least some of the tuples which define a colour may comprise a first element providing a value for a red colour channel, a second element providing a value for a green colour channel, a third element providing a value for a blue colour channel and a fourth element providing a transparency value.

In some embodiments of the invention the read floating point values define a bounded range, and the method further comprises: reading integer data indicating a number of points within said bounded range; reading a plurality of integer data items, each identifying one of said points within said bounded range; and generating for each integer data item a floating point position value based upon the respective integer data item, the bounded range and the number of points within the bounded range.

Such a method provides a degree of quantization and means that only the data defining the bounds of the bounded range need be stored in floating point form, thereby further reducing floating point data storage requirements.

According to a further aspect of the present invention, there is provided a method of generating a stored representation of graphical data, the method comprising reading a plurality of signed floating point values providing a representation of said graphical data; storing a plurality of unsigned floating point values based upon said read floating point values, each unsigned floating point value being stored only once; and storing a plurality of integer values, each integer value identifying a stored floating point value and being associated with a read floating point value.

The floating point values may represent any component of the graphical data including, for example, points in vector space which define the graphical data, colour data or any other components which may be used to represent the graphical data.

Each of said integer values may have an associated sign based upon the sign of a respective read floating point value.

The read floating point values may define a plurality of tuples and the stored integer values may define a plurality of tuples.

Each of said tuples may define a point in a vector space.

The method may further comprise storing a plurality of vertex data items, each vertex data item identifying one of said tuples of integer values and each vertex data item representing a vertex in said graphical data. The method may further comprise storing data representing a plurality of polygons based upon said vertex data items. The polygons may be triangles.

At least some of said tuples may define a colour. The at least some of said tuples which define a colour may comprise a plurality of elements, each element providing a value for a respective colour channel. For example, such tuples may comprise a first element providing a value for a red colour channel, a second element providing a value for a green colour channel, a third element providing a value for a blue colour channel and a fourth element providing a transparency value.

The graphical data may represent an interconnection of fluid flow control components such as valves, filters and so on. Such graphical data may be useful in allowing visualisation of the interconnection of fluid flow control components.

Aspects of the invention can be implemented in any convenient form including by way of suitable methods, systems and apparatus. Aspects of the invention can be implemented by way of a computer. As such computer-implemented methods in which each step is carried out by a suitably programmed processor are provided. Similarly, aspects of the invention provide computer readable media comprising computer executable instructions configured to cause a computer to carry out a method as described above. Such computer readable media include tangible media (e.g. discs) and intangible media (e.g. communications signals). Further aspects of the invention provide computer readable media storing a representation of graphical data generated using a method as described above.

Where aspects of the invention are implemented by way of a computer, there may be provided a computer apparatus comprising a memory (e.g. a random access memory) storing processor readable instructions and a processor configured to read and execute instructions stored in said memory. The processor readable instructions may comprise instructions configured to cause the processor to carry out a method as set out above.

An embodiment of the invention will now be described, by way of example, with reference to the accompanying drawings, in which:

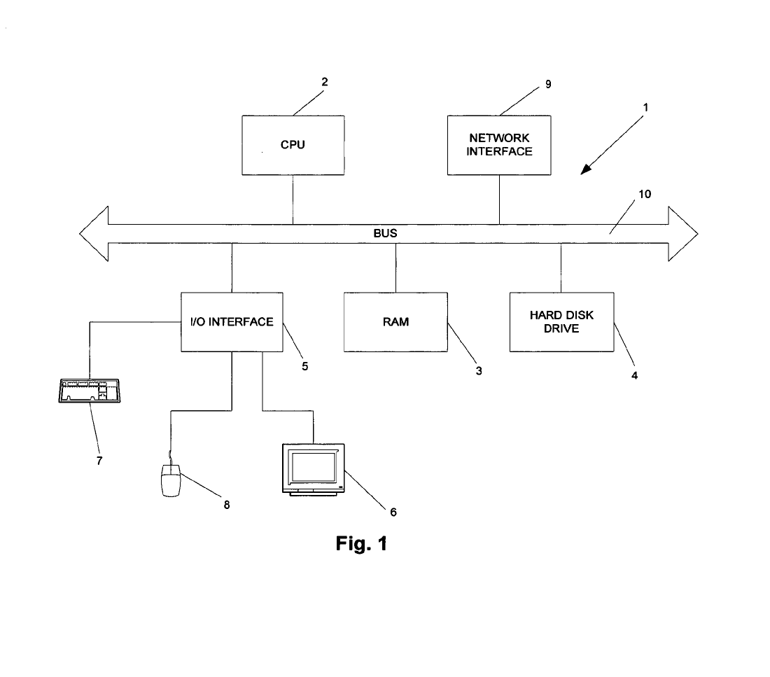

FIG. 1 is a schematic illustration of a computer on which embodiments of the invention can be implemented;

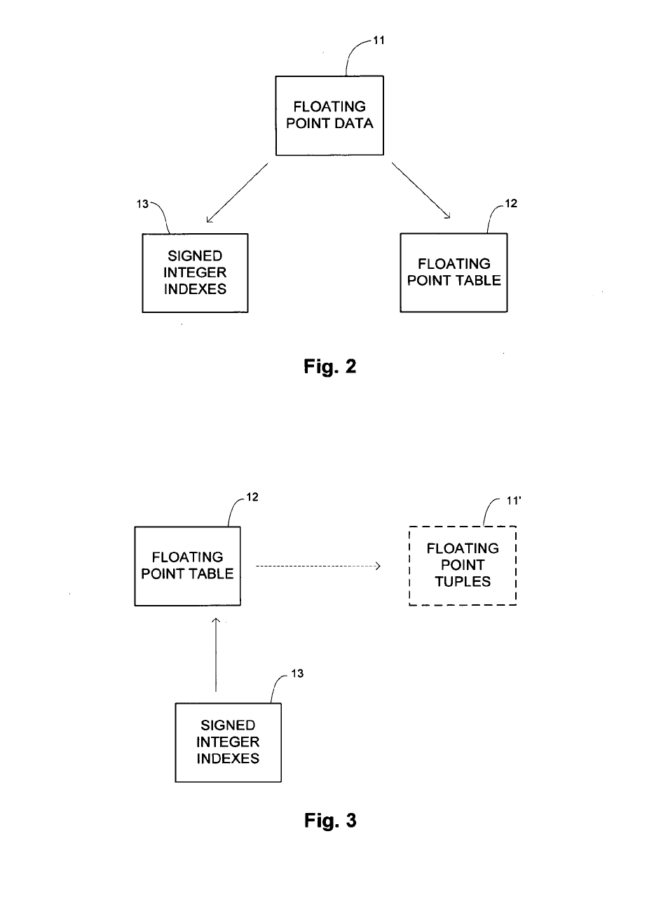

FIGS. 2 and 3 are schematic illustrations of a method for storing and recovering floating point data in accordance with an embodiment of the invention;

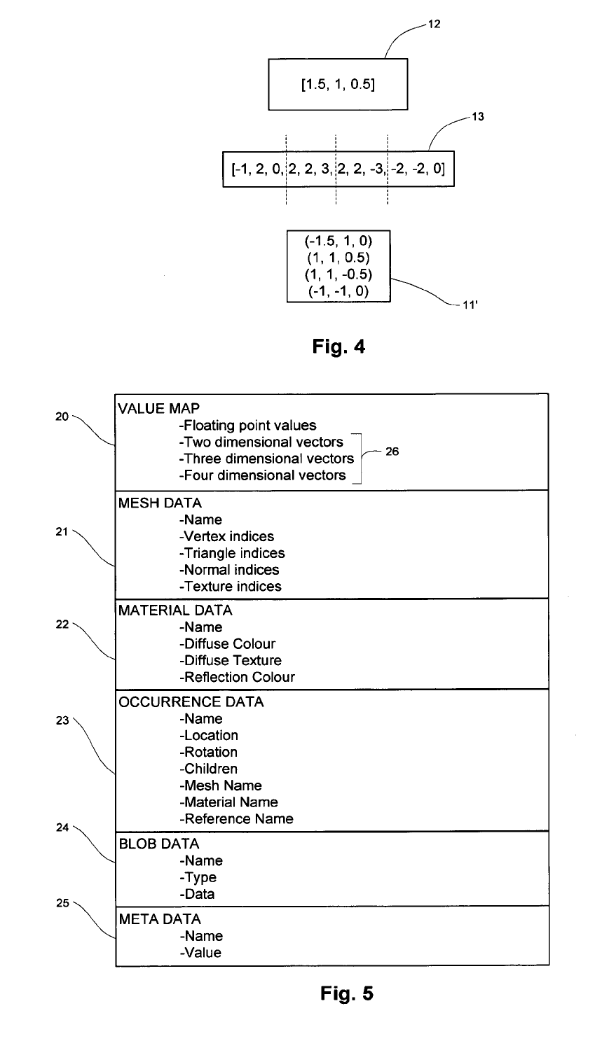

FIG. 4 is a schematic illustration of an example of data stored using the method of FIGS. 2 and 3;

FIG. 5 is a schematic illustration of a data file used to store data in some embodiments of the present invention.

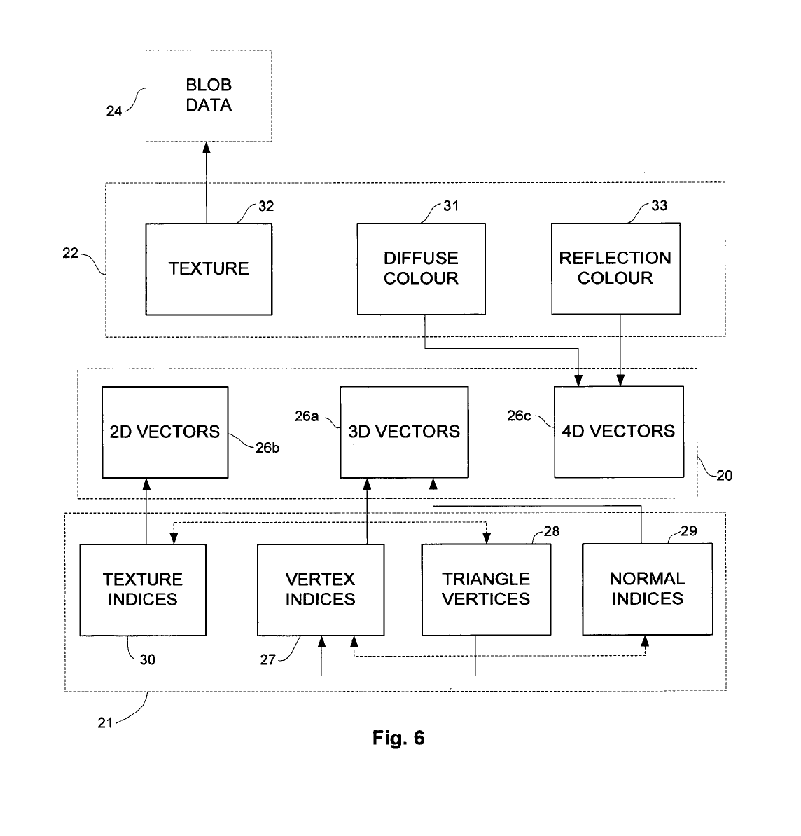

FIG. 6 is a schematic illustration of relationships between data items in the data file of FIG. 5;

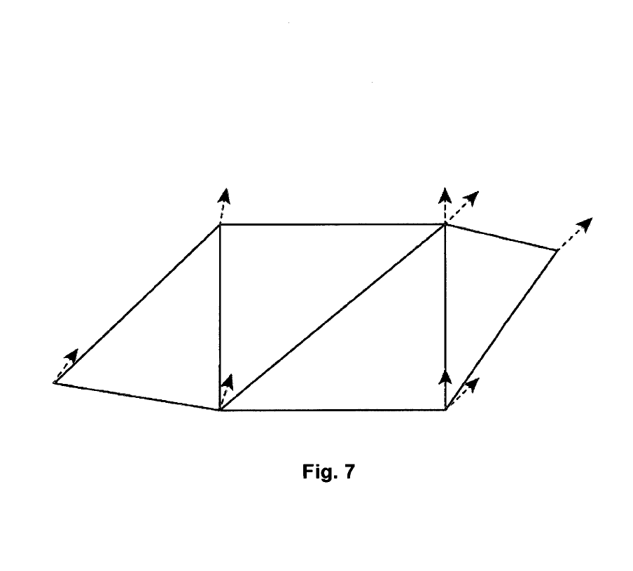

FIG. 7 is an isometric projection of an example three-dimensional surface to be represented by data having the form shown in FIG. 5;

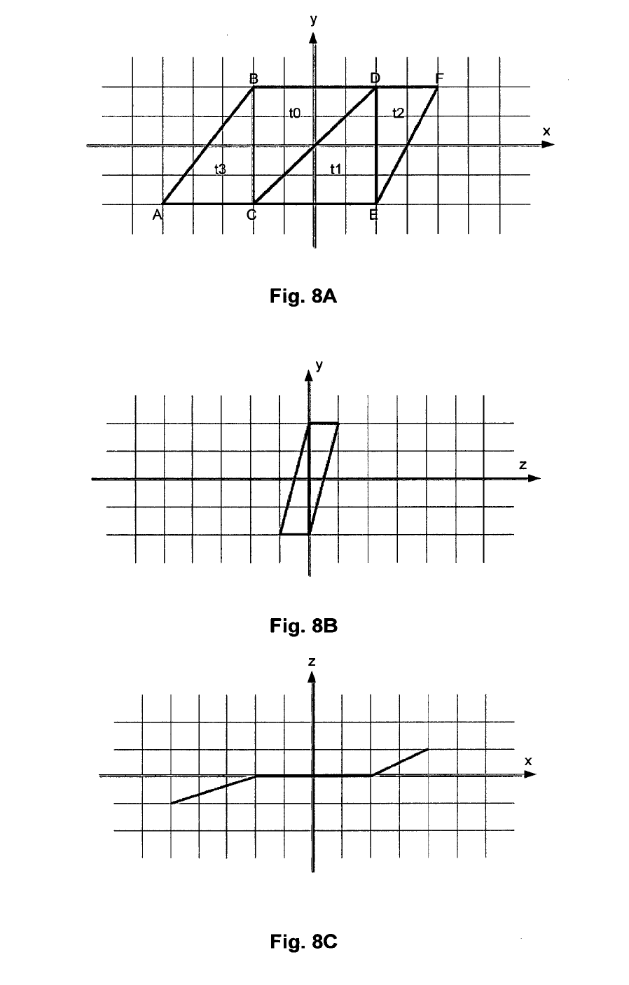

FIGS. 8A to 8C are views of the three-dimensional surface of FIG. 7 in the x-y, z-y and x-z planes respectively;

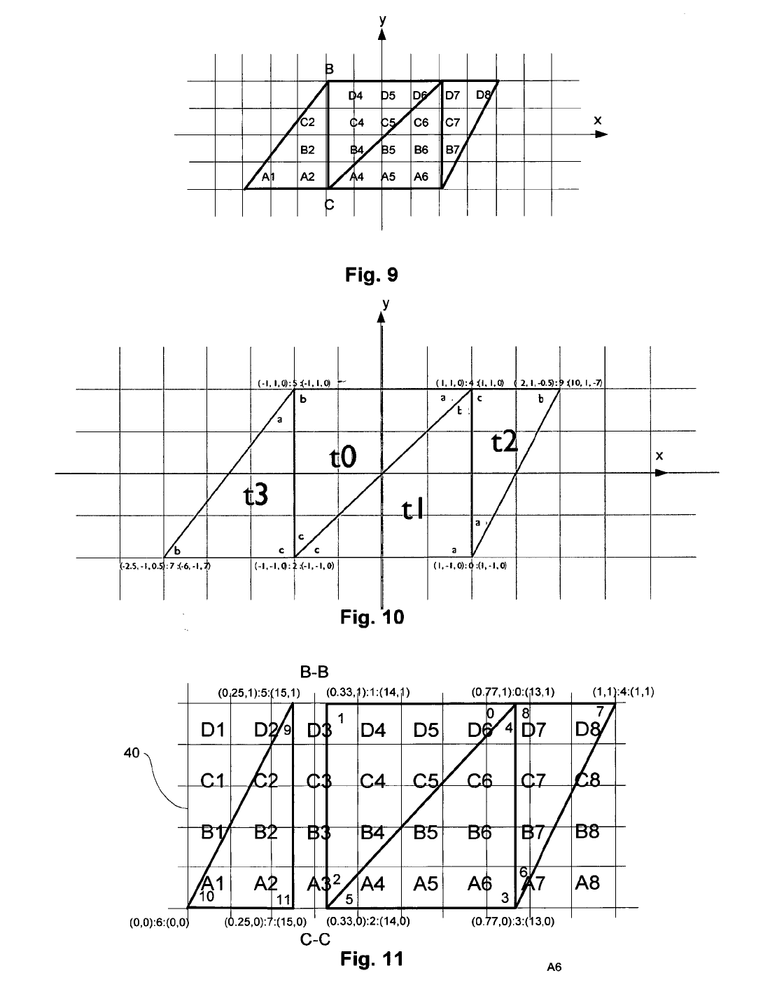

FIG. 9 is a view of the three-dimensional surface of FIG. 7 in the x-y plane after application of a particular texture;

FIG. 10 is an annotated depiction of the surface of FIG. 7 in the x-y plane;

FIG. 11 is an illustration of the application of a texture to the surface of FIG. 7, shown in the x-y plane;

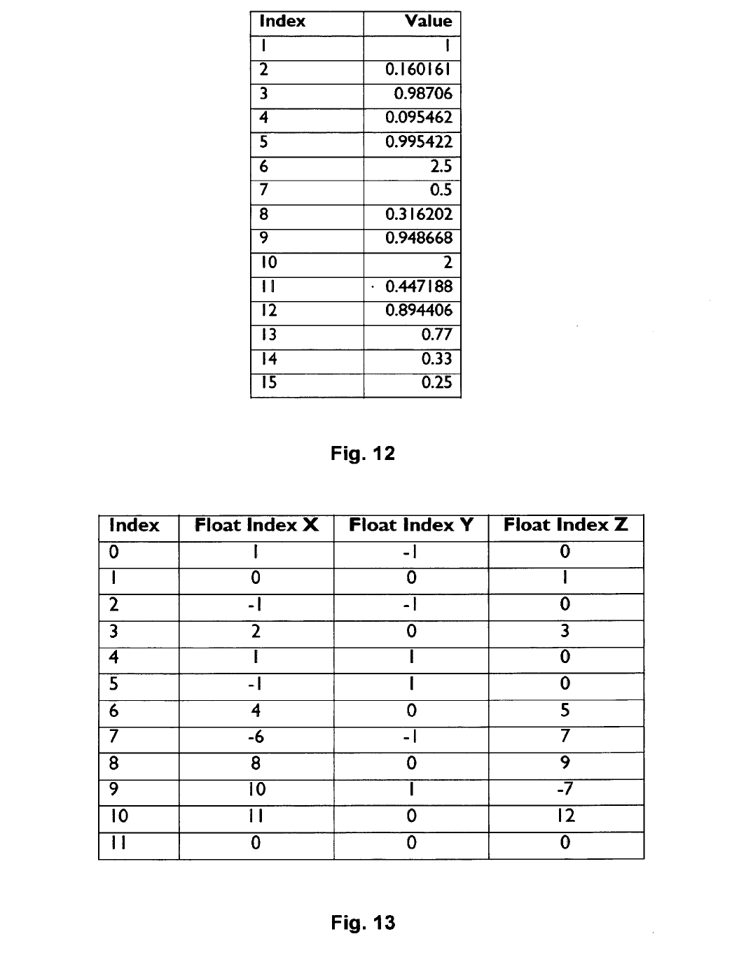

FIGS. 12 to 19 are tables containing data stored to represent the surface of FIG. 7; and

FIG. 20 is a schematic illustration of data processed in an embodiment of the invention.

FIG. 1 shows a computer 1 on which embodiments of the invention can be implemented. The computer 1 comprises a CPU 2 which is configured to read and execute instructions stored in a volatile memory 3 which takes the form of a random access memory (RAM). The volatile memory 3 stores instructions for execution by the CPU 2 and data used by those instructions. For example, image data may be generated and manipulated by the instructions and such image data may be stored in the volatile memory 3.

The computer 1 further comprises non-volatile storage in the form of a hard disc drive 4. The hard disc drive 4 may provide persistent storage for image data which is to be processed by the computer 1. The computer 1 further comprises an I/O interface 5 to which are connected peripheral devices used in connection with the computer 1. More particularly, a display 6 is configured so as to display output from the computer 1. Input devices are also connected to the I/O interface 5. Such input devices may include a keyboard 7 and a mouse 8 which allow user interaction with the computer 1. It will be appreciated that the computer 1 may have other input interfaces, for example where the computer 1 is a portable computer it may include any suitable portable computer interface such as a touch screen.

A network interface 9 allows the computer 1 to be connected to an appropriate communications network so as to receive and transmit data from and to other computers. The CPU 2, volatile memory 3, hard disc drive 4, I/O interface 5, and network interface 6, are connected together by a communications bus 10 to allow communication therebetween.

As has been discussed above, the computer 1 is configured to manipulate representations of graphical data. Techniques for such manipulations are now described.

Graphical data used in embodiments of the invention is vector data. Such data comprises, amongst other things, a plurality of vector positions in vector space, together with details defining the connectivity of those vector positions to define shapes which in turn define the graphical data. Such vector positions are routinely stored as floating point number tuples having as many elements as there are dimensions in the vector space to be represented. The use of floating point numbers in computing will be well-understood by one of ordinary skill in the art, being a common form for the storage of non-integer real numbers. While floating point numbers offer precision, their use can be disadvantageous in that they require relatively large storage space.

There is now described a technique which allows floating point data storage to be minimised, while at the same time allowing storage of graphical data with precision. This is described with reference to FIG. 2.

FIG. 2 schematically shows floating point data 11 which comprises a plurality of floating point triples, each having three values and defining a vector position in three dimensional space. The floating point triples are processed to generate a floating point table of values 12 and signed integer indices 13. In general terms, the magnitude of each distinct floating point value included in the floating point data 11 is stored in the floating point table of values 12 exactly once. Each of the triples is then represented by three signed integer values (one for each element) included in the signed integer indices 13, each integer value identifying one of the floating point values stored in the floating point table of values 12 and having a sign corresponding to that of the element of the triple which it represents.

For example, where a vector (3.45, 2.86, and −3.45) is included within the floating point data 11, the floating point table of values 12 will include:

3.45 2.86

The signed integer indices will then represent the vector by values of [1, 2 −1]. That is, the signed integer index ‘1’ identifies the first value in the floating point table of values 12 being 3.45. Given that 1 is positively signed, this indicates that the value should be read with no sign modification. The signed integer index ‘2’ identifies the second value in the floating point table of values 12 being 2.86. Again, given that ‘2’ is positively signed, the value is read with no sign modification. The signed integer index ‘−1’ also indentifies the first value in the floating point table of values. However given that this index is negatively signed, the value is read with sign inversion to give −3.45.

It can be seen from the preceding description that where a floating point value of particular magnitude occurs more than once within the floating point data 11 (be that within a single vector or multiple vectors) it need only be stored once, thereby reducing storage requirements. It will be appreciated that storing signed integer indices 13 is relatively space efficient as compared with storage of floating point values.

In the arrangement described above, an index of 0 is arranged to index a floating point value of 0 which need not be stored in the floating point table of values 12.

In addition to representing positions in vector space, floating point tuples of the type described above can be used to store colour data. Specifically, where a four-element tuple is used, three elements can be used to store colour channel data for red, green and blue channels and a fourth element can be used to store a transparency (or alpha) value. Such tuples can again be represented using the floating point table of values 12 in combination with the signed integer indices 13.

FIG. 3 shows the process of reconstructing floating point triples 11′, each representing a point in vector space from the stored floating point table of values 12 and the signed integer indices 13. The process for reconstructing tuples of other dimensions is analogous. The signed integer indices 13—there being one for each value of each triple—act as indices into the floating point table of values 12 so as to generate the floating point triples 11′.

The process of reconstructing the floating point triples 11′ is now described with reference to an example illustrated in FIG. 4.

The Floating point table 12 contains the values [1.5, 1, 0.5].

The signed integer indices 13 contains follows values [−1, 2, 0, 2, 2, 3, 2, 2, −3, −2, −2,0]

The signed integer indices are interpreted such that each three indices (reading from left to right) represent a single triple being a position in vector space. The signed integer indices 13 therefore represent four triples. The triples are separated in this way by dotted lines in FIG. 4. As such, the signed integer indices 13 when applied to the floating point table 12, generates four vector positions which make up the floating point triples 11′: (−1.5, 1, 0); (1, 1, 0.5); (1, 1, −0.5); and (−1, −1, 0).

The preceding description has explained how the use of a floating point table of values and a set of signed integer indices allows floating point tuples to be stored in a space-efficient manner. It has been explained that such a representation can be used to represent points in vector space or to represent colour data. Indeed, it will be appreciated that any floating point values can be generally stored in the manner described above, there being an expected saving in the storage requirements where a floating point number of particular magnitude occurs more than once in the floating point values.

There is now described a file format which can be used to store data of the type described above—together with associated data—so as to represent graphical data.

FIG. 5 shows a data file having six logical components. A first component provides a value map 20 storing floating point data in a manner described above. A second component stores mesh data 21 which refers to parts of the value map 20 so as to define graphical geometry. A third component provides material data 21 which indicates colour and/or texture data. A fourth component defines occurrences 23 of particular graphical objects, while a fifth component defines “blob” (Binary Large Object) data 24. A sixth component provides metadata 25.

Each of these components is now described in further detail with reference to FIGS. 5 and 6. FIG. 6 shows relationships between the some of the data items stored in each of the components described with reference to FIG. 5. In FIG. 6 solid directional arrows represent a store reference between one data item and another, and broken directional arrows represent that data items are stored in corresponding order so as to allow their association.

The first component which provides the value map 20 includes the table of floating point values 12 and the signed integer indices 13 which have been discussed above. The signed integer indices 13 are represented by three sets of vectors 26, respectively storing two, three and four dimensional vectors, 26a, 26b, 26c. Each set of vectors includes a plurality of signed integer values (one for each vector element) which index the table of floating point values in the manner described above. The two and three dimensional vectors 26a, 26b, are used to represent positions in vector space, while the four dimensional vectors 26c are used to represent colour in the manner outlined above.

The mesh data 21 may have one or more instances, each defining a mesh. Each instance has a name which takes the form of a string. The mesh data 21 also comprises vertex indices 27, each vertex index being an unsigned integer which refers to a three-dimensional vector in the value map 20. Triangle vertices 28 define how the vertices are joined together to define triangles. Each triangle vertex refers to one of the vertex indices 27 which in turn refers to a three-dimensional vector in the value map 20, as noted above.

The mesh data 21 further includes normal indices 29, one for each vertex referred to by the vertex indices 27. Each normal index refers to a three-dimensional vector in the value map 20. The normal indices are stored in an order corresponding to that of the vertex indices, thereby allowing vertices and their normals to be associated together. It will be appreciated that vertex normals are required to allow proper rendering of the mesh, and the use of normal vectors in graphical rendering will be known to those of ordinary skill in the art.

Finally, the mesh data 21 includes texture indices 30, each texture index referring to a two-dimensional vector in the value map 20. Each texture index applies to a respective one of the triangle indices, and the texture indices are stored in the same order as the triangle indices. Each two-dimensional vector is used to indicate a position within a planar texture which should be located coincident with the respective triangle vertex.

Moving now the material data 22, each instance has a name provided in the form of a string, a diffuse colour 31 which is provided as an integer referencing a four-dimensional vector in the four dimensional vectors 26c of the value map 20, a diffuse texture 32 which is provided as a reference to an instance of blob data 24 (described below), and a reflection colour 33 which is provided as an integer referencing a four-dimensional vector in the four dimensional vectors 26c of value map 20. It will be appreciated that not all instances of the material data 22 need have both texture and colour data.

The occurrence data 23 has instances which use the defined constructs to create objects. Each instance has a name which takes the form of a string, and a location which takes the form of an index identifying a three-dimensional vector stored in the value map 20. The location identifies a point in three-dimensional space at which the occurrence is located. A rotation again indentifies a three-dimensional vector which provides rotation information. Hierarchies of occurrences can be created, and child data defines such hierarchies. Such hierarchies can be used to define a complex object from component parts, where a root instance represents an object and the child objects define its component parts. In such a case, location and rotation data for child objects is specified relative to their parent object.

Each occurrence includes a mesh name and material name which are strings respectively referring to an instance of the mesh data and material data described above. A reference name takes the form of a string which identifies another occurrence instance, thereby allowing two instances of a particular graphical object to be defined, one referencing the other to allow common properties to be shared, but each occurrence to have its own position and location area.

In some embodiments, unnamed instances of some components may be created and used to provide a default where no instance of a particular component is specified. For example, where an occurrence instance fails to identify a mesh component instance by name, that occurrence instance may use data taken from an instance of mesh data having no name.

Blob data 24 is arranged to store byte strings of data. Each instance comprises name and type data (both strings) and a byte array representing the data.

Meta data 25 stores data relating to the graphical data in the form of name, value string pairs.

It will be appreciated that the various components set out above and the various data items included within those components may, in general terms, occur zero or more times within a particular example data file, depending upon the nature of the data to be represented.

An example of use of data such as that described above is now presented with reference to FIGS. 7 to 11. The examples relate to a representation of a three dimensional surface shown in FIG. 7 in isometric projection. FIG. 8A shows the surface in the x-y plane, FIG. 8B shows the surface in the z-y plane, and FIG. 8C shows the surface in the x-z plane.

Referring to FIG. 7 it can be seen that each vertex has one ore more normals (indicated by a dotted line) which is used when the surface is a lit within a scene, and these are described further below.

Referring to FIG. 8A, six vertices are labelled A to F. It can be seen that the surface comprises four triangles labelled t0, t1, t2, t3. The triangles t0 and t3 have two coincident vertices B, C. The triangles t0 and t1 have two coincident vertices C, D. The triangles t1 and t2 have two coincident vertices D, E. From FIG. 7 it can be seen that two normals are shown at the vertices D and E. As such, each of vertices D and E are separately represented in the stored data, each with a respective normal. This is because the surface is not flat at these vertices.

FIG. 9 shows the mesh in the x-y plane after application of a particular texture. The texture is formed of a sequence of labelled squares. The discontinuity in the texture along a line joining the vertices B and C is attributable to the way in which the texture is applied to the surface as described further below.

Reference is made to FIGS. 12 to 19 which are tables of data stored to represent the surface of FIGS. 7 to 11 in the form described with reference to FIG. 5.

FIG. 12 shows the floating point data stored as part of the value map 20. It comprises an index and a corresponding floating point value. Indices for stored floating point values start from 1 so as to allow the index 0 to be used to represent the floating point value zero which need not be stored. As discussed above, each of the stored floating point values is positive.

FIG. 13 shows the three-dimensional vectors stored as part of the value map 20. Twelve vectors are stored, each having an index and three integer values respectively identifying a floating point value in the floating point data of FIG. 12 for x, y and z components. The integers stored are signed, and the sign is applied to the value retrieved from the floating point data of FIG. 12 as has been described above.

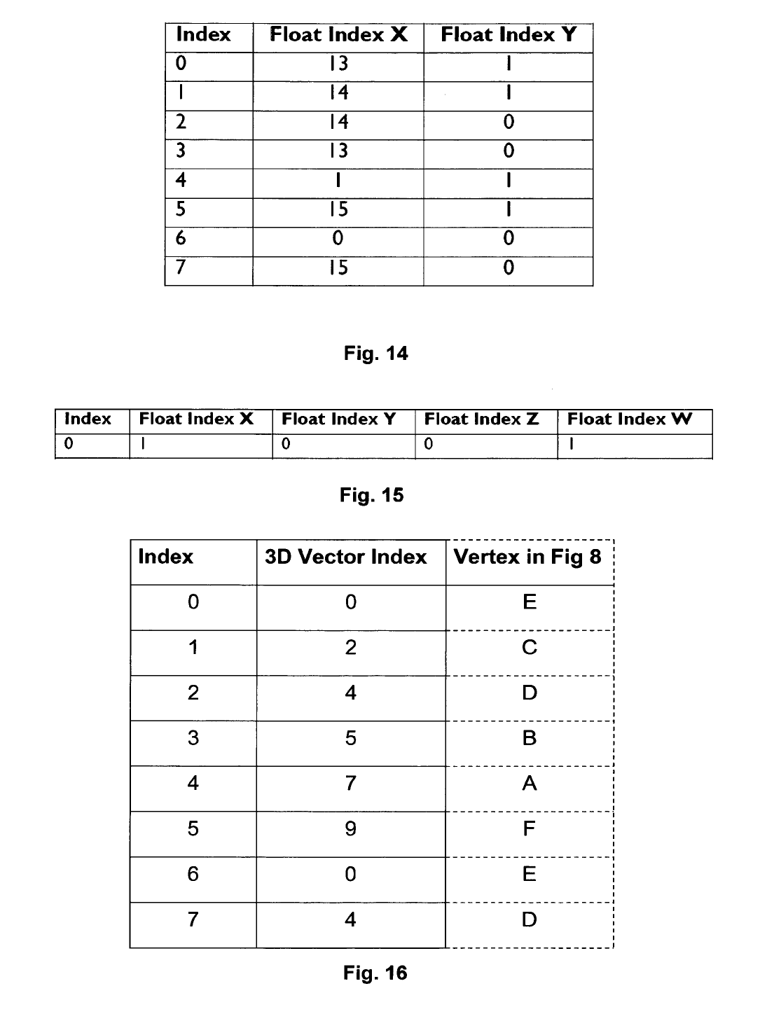

Similarly, FIG. 14 shows two-dimensional vectors stored in like manner. Each has an index and two integer values which refer to values in the floating point data of FIG. 12.

FIG. 15 shows a single stored four-dimensional vector. Here, the stored vector has an index and four integer values each respectively identifying a floating point value in the floating point data of FIG. 12.

The data of FIGS. 12 to 15 together makes up the value map 20 described above.

FIG. 16 shows the vertex indices which are stored as part of the mesh data 21 defining the surface of FIGS. 7 to 11. The stored data comprises an index and an index identifying a three-dimensional vector. For ease of reference, FIG. 14 shows how the vertex labels in FIG. 6A correspond to each of the vertices for which data is stored. It can be seen that the vertices D and E are both represented by two vertex data items given that as noted above, each of these vertices has two normals, one associated with the triangle t1 and one associated with the triangle t2.

Referring now to FIG. 10, the surface is again shown in the x-y plane. Each vertex is annotated in the form:

(x1,y1,z1):vector index:(x2, y2, z2)

### Where

vector index is an index into the table of FIG. 13;
(x1, y1, z1) is a vector of values retrieved from the floating point data based upon the indices (x2, y2, z2) which are provided by the table of FIG. 13 when indexed using the vector index value.

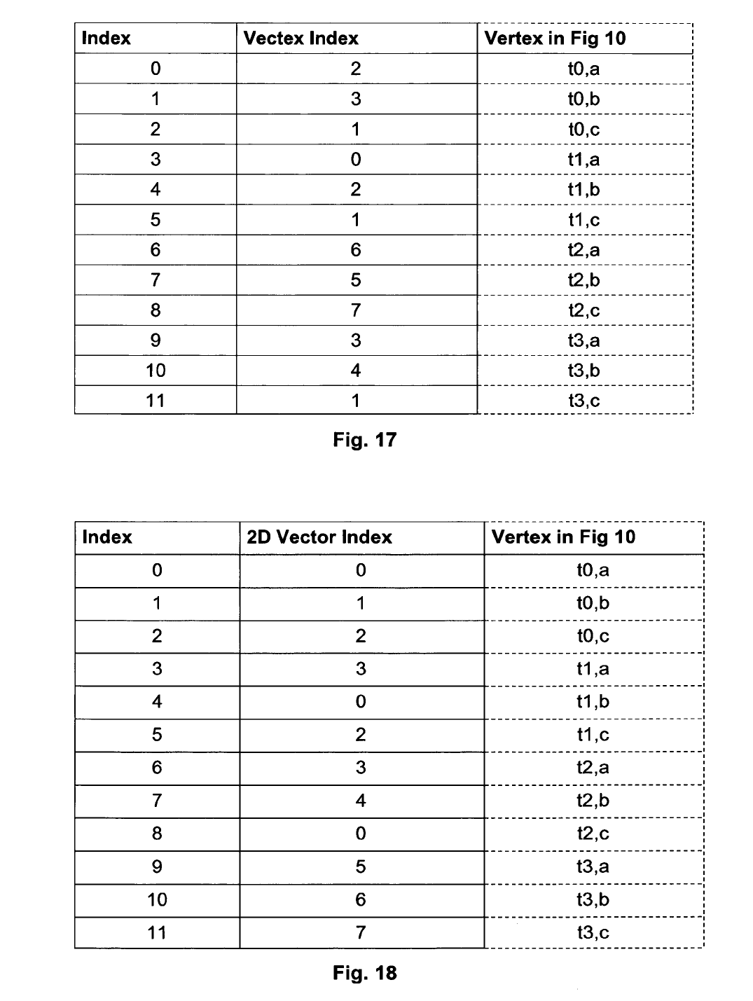

FIG. 17 shows triangle vertices used to represent the surface of FIG. 5. The stored data comprises indices each having a reference to the vertex indices stored in the table of FIG. 16. For ease of reference, FIG. 17 additionally shows which triangle vertex, in FIG. 10, is represented by each data item. Specifically each triangle vertex is labelled in FIG. 17 with a number indicating a triangle to which it belongs (of the triangles t0, t1, t2, t3, t4) and a letter (a, b or c) identifying one of the vertices of that triangle, those letters being shown in FIG. 10. It can be seen from FIG. 10, for example, that the vertex labelled c in each of the triangles t0, t1 and t3 is coincident. It can further be seen that in FIG. 17 each of these vertices refer to the same vertex data item in the table of FIG. 16. In contrast, the coincident vertices t1,a and t2,a refer to different vertex data items given that they have a different normals (as can be seen in FIG. 5).

Referring now to FIG. 18, texture index data is described. This includes a value for each triangle index (stored in the table of FIG. 17), and the data of the table of FIG. 18 is stored in the same order as that of the table of FIG. 17. For each triangle index there is stored a two dimensional vector which identifies a point within the two-dimensional plane of the texture 40 to be applied (FIG. 11) to the corresponding triangle index. The stored data comprises an index and an appropriate reference to a two-dimensional vector in the table of FIG. 14. FIG. 18 also, in the manner of FIG. 17 shows how each entry refers to a triangle vertex.

Referring to FIG. 11, each vertex is annotated with a number within the triangle identifying one of the texture index entries in the table of FIG. 18. Each vertex is also annotated, outside the respective triangle, in the form:

(u1,v1):vector index:(u2, v2)

### Where

vector index is an index into the table of FIG. 14;
(u1, v1) is a vector of values retrieved from the floating point data based upon the indices (u2, v2) which are provided by the table of FIG. 14 when indexed using the vector index value.

In general terms, the application of a texture to a surface made up of triangles in the manner described above will be well known to those of ordinary skill in the art. Briefly, each two-dimensional vector identifies a point within the plane of the texture 40. The triangle vertex associated with that two-dimensional vector is located at that point within the plane of the texture 40. The surface is shown relative to the continuous texture in FIG. 12, and because the texture is to be applied discontinuously, the surface is broken in FIG. 12 at the vertices B and C.

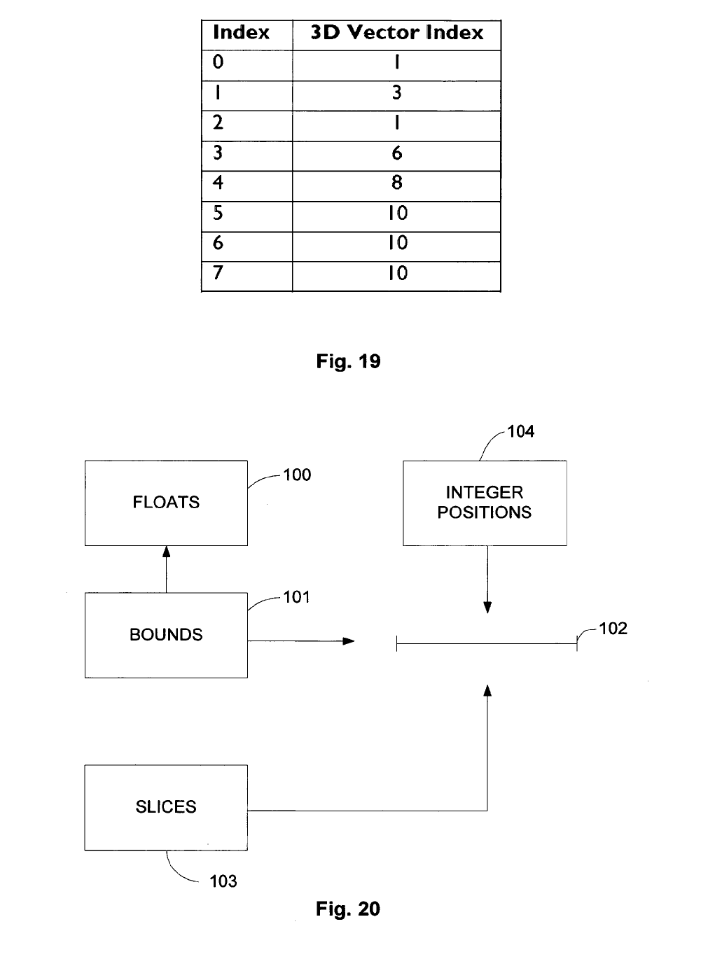

FIG. 19 shows vertex normal data, one entry being stored for each vertex of the vertex data of FIG. 16. The data in FIG. 19 is stored in the same order as that of FIG. 16.

It will be appreciated that the data of FIGS. 16 to 19 together defines the mesh data 21 of FIG. 5.

Where the surface of FIGS. 7 to 11 is represented in the form described above with reference to FIG. 5, it has been found that the total storage space required is reduced by a factor of 4.126. Given that the compression is lossless (i.e. the originally data can be exactly recovered) compression ratios vary considerably depending upon the data to be represented. A test of 1788 data sets shows a minimum compression ratio of 1.148:1 and a maximum compression ratio of 8:1, the average being 1.866:1

Various modifications can be made to the embodiments which have been described above.

For each instance of occurrence data, a bounding box may be defined (for example using a pair of maximum and minimum three-dimensional vectors). Such bounding boxes define the location of the occurrence in three-dimensional space before the processing of the occurrence is complete, thereby allowing an overall arrangement of occurrences within a scene to be determined prior to completion of rendering.

Additionally or alternatively, each occurrence may further comprise a pair of three dimensional vectors which are used during animation of a three-dimensional model. A first vector may indicate a direction of travel for the occurrence during the animation, while a second vector may indicate a direction of rotation along the direction of travel in which the occurrence is to rotate during the animation. These three dimensional vectors can be stored in the form described above using floating point data and referencing integers.

An alternative way of storing vector position data is now described with reference to FIG. 20. Floating point data 100 is stored with associated indices. The floating point data 100 is indexed by integer values as before. Here, the integer values define bounds 101 within which graphical data is to be defined. The integer values are used to look up values stored as part of the floating point data 100 so as to provide floating point values defining the bounds. In one-dimensional terms the bounds define a range along a one-dimensional line 102.

Integer slice data 103 defines an integer number of positions along the one-dimensional line 102, such that integer position data 104 can then identify a particular one of the slices (or positions). In this way, the only floating point data which must be stored is that used to define the bounds, the remaining data all being stored in integer form.

Specifically, where the bounds 101 define MinBound and MaxBound representing minimum and maximum bounds respectively by indexing appropriate floating point values; the number of slices is given by NumSlices, and the stored values are each represented by m, a floating point value based upon each stored integer position value m can be obtained using:

Value=MinBound+((MaxBound−MinBound)*m)/NumSlices)

It will be appreciated that storing data in this way provides some degree of quantization.

The method described with reference to FIG. 20 can be employed to represent any floating point numerical data. The floating point data takes the same form as was described in earlier embodiments, while the integer values now comprise a set of integers defining the bounds 101, a single integer (in each dimension) defining a number of slices, and a set of integers defining vector positions.

A simple one dimensional example is now presented.

In the example, the floating point data 100 stores a single value [1.0]. The bounds 101 store two signed integer values [−1, 1] thereby defining a range between −1.0 and 1.0.

The integer slice data 103 indicates that five slices are used.

Given values [−1, 1, 4, 2, 5], which make up the positions 104, these values can be converted into values within the bounded range −1 to 1 using:

value=−1+((1−(−1))*read_value)/5

### Giving [−1.4, −0.6, 0.6, −0.2].

Although various embodiments have been described above, it will be appreciated that these embodiments are for presented for the purposes of illustration only and are not intended to limit the scope of the claimed invention. It will be readily apparent to the skilled person that various modifications can be made to the described embodiments without departing from the spirit and scope of the present invention.

1. A method of generating a representation of graphical data based upon a plurality of stored floating point data values and a plurality of stored integer values, the method comprising:
reading a plurality of said integer values;
reading a plurality of said floating point data values, each read floating point data value being based upon a respective read integer value; and
generating a representation of said graphical data based upon said plurality of read floating point data values.

2. A method according to claim 1, wherein each of the integer values has an associated sign, each of said floating point values is unsigned, and reading said plurality of floating point values comprises modifying a sign of at least some of the read floating point values based upon the sign of the respective read integer value.

3. A method according to claim 1, wherein said plurality of integer values define a plurality of tuples and said generating comprises generating a plurality of tuples representing features of said graphical data.

4. A method according to claim 3, wherein at least some of said tuples define respective points in a vector space.

5. A method according to claim 3, wherein said generating further comprises reading a plurality of vertex data items, each vertex data item identifying one of said tuples and each vertex data item representing a vertex in said graphical data.

6. A method according to claim 5, wherein said graphical data is represented by a plurality of polygons and said generating generates said polygons from said vertex data items.

7. (canceled)

8. A method according to claim 5, wherein some of said tuples represent a point in a two-dimensional texture, said point in said two-dimensional texture being associated with one of said vertices and said generating comprises generating graphical data in which said point in said two dimensional texture is applied to a specified one of said vertices.

9. (canceled)

10. A method according to claim 3, wherein at least some of said tuples define a colour.

11. A method according to claim 10, wherein the at least some of said tuples which define a colour comprise a plurality of elements, each element providing a value for a respective colour channel.

12. A method according to claim 11, wherein the at least some of the tuples which define a colour comprise a first element providing a value for a red colour channel, a second element providing a value for a greed colour channel, a third element providing a value for a blue colour channel and a forth element providing a transparency value.

13. A method according to claim 1, wherein said read floating point values define a bounded range, and the method further comprises:
reading integer data indicating a number of points within said bounded range;
reading a plurality of integer data items, each identifying one of said points within said bounded range;
generating for each integer data item a floating point position value based upon the respective integer data item, the bounded range and the number of points within the bounded range.

14. A method of generating a stored representation of graphical data, the method comprising:
reading a plurality of signed floating point values providing a representation of said graphical data;
storing a plurality of unsigned floating point values based upon said read floating point values, each unsigned floating point value being stored only once; and
storing a plurality of integer values, each integer value identifying a stored floating point value and being associated with a read floating point value.

15. A method according to claim 14, wherein each of said integer values has an associated sign based upon the sign of a respective read floating point value.

16. A method according to claim 14, wherein said read floating point values define a plurality of tuples and said stored integer values define a plurality of tuples.

17. A method according to claim 16, wherein each of said tuples defines a point in a vector space.

18. A method according to claim 16, further comprising storing a plurality of vertex data items, each vertex data item identifying one of said tuples of integer values and each vertex data item representing a vertex in said graphical data.

19. A method according to claim 18, wherein further comprising storing data representing a plurality of polygons based upon said vertex data items.

20. (canceled)

21. (canceled)

22. A method according to claim 14, wherein the at least some of said tuples define a colour and comprise a plurality of elements, each element providing a value for a respective colour channel.

23. A method according to claim 22, wherein the at least some of the tuples which define a colour comprise a first element providing a value for a red colour channel, a second element providing a value for a green colour channel, a third element providing a value for a blue colour channel and a fourth element providing a transparency value.

24. (canceled)

25. A non-transitory computer readable medium comprising computer executable instructions configured to cause a computer to carry out a method according to claim 1.

26. (canceled)

27. (canceled)
